(19) United States
(12) Patent Application Publication
(10) Pub. No.: US 2012/0072449 A1
(43) Pub. Date: Mar. 22, 2012

(54) OBJECT INSTANCE VERSIONING

(75) Inventors: Raymond R. Patch, Redmond, WA (US); Daniel K. Lin, Redmond, WA (US); Rajeev S. Chauhan, Issaquah, WA (US)

(73) Assignee: Microsoft Corporation, Redmond, WA (US)

(21) Appl. No.: 12/884,185

(22) Filed: Sep. 17, 2010

(51) Int. Cl. G06F 17/30

(52) U.S. Cl. 707/770; 707/812; 707/E17.014; 707/E17.044

(57) ABSTRACT

A first version of object data for an object instance can be stored in an object persistence store, which can be a distributed store. After the first version of the object data is stored, a second version of the object data can be stored in the store, without deleting the first version of the object data. Object data versioning information that identifies the first version of the object data and the second version of the object data can be stored separately from method versioning information for the object instance. After the second version of the object data is stored, a request to retrieve the first version of the object instance can be received, and in response, the first version of the object data can be retrieved from the store. Multiple versions of the object instance data can also be searched.

### BACKGROUND

It has been known to maintain historical versions of computer files. Maintenance of historical versions is known as versioning. As used herein, references to versions, versioning and similar terms refer to historical versions, historical versioning, etc., where the versions are maintained in a sequential order corresponding the historical order of the versions. In some systems versioning of files is turned off by default, but may be turned on to enable versioning. Assembly versioning has also been done. Assembly versioning can maintain and track historical versions of computer code assemblies when developing software. For example, this can be done when packaging the assemblies for software deployment.

### SUMMARY

Whatever the advantages of previous versioning tools and techniques, they have neither recognized the object instance versioning tools and techniques described and claimed herein, nor the advantages produced by such tools and techniques. As used herein, an object instance is a unit of computer-readable information that can include data (e.g., instances of object properties) and a method (which may include one or more sub-methods). An object method as used herein is program information related to the object. For example, a method may be a class or other information related to the object instance, such as presentation information, information about routines related to the object instance, etc. Object instances can be instances of objects other than files. Examples of object instances include .NET object instances, which are instances of objects within the Microsoft®.NET software framework.

In one embodiment, the tools and techniques can include receiving a request to store a first version of an object instance in an object persistence store. The technique can also include storing a first version of object data for an object instance in the object persistence store in response to the request. After the first version of the object data is stored, a request to store a second version of the object instance in the object persistence store can be received. The second version of the object data can be stored in the store in response to the request to store the second version of the object instance, without deleting the first version of the object data. Object data versioning information that identifies the first version of the object data and the second version of the object data can be stored separately from method versioning information for the object instance. After the second version of the object data is stored, a request to retrieve the first version of the object instance can be received, and in response, the first version of the object data can be retrieved from the store.

As used herein, object data versioning information and the object method versioning information are stored separately from each other if the two types of information are maintained so that the method and data versions are not merely the same as each other. Accordingly, a single method version may correspond to multiple data versions and/or vice versa. The data and method versioning information may be stored separately in the same data structure or in separate data structures, or the method versioning information may not be stored.

In another embodiment of the tools and techniques, a distributed object persistence store can be configured to store multiple versions of object data for object instances in response to receiving requests to store the object instances. Upon receiving a request to retrieve an object instance, the store can be configured to identify a version of the object data responsive to the request and to return the identified version. Clients can be configured to request storage of object instances in the distributed object persistence store and to request retrieval of the object instances from the distributed object persistence store.

In yet another embodiment of the tools and techniques, multiple versions of object data for one or more object instances can be stored in an object persistence store in response to receiving requests to store the one or more object instances. A query requesting a search of the object data can be received, where the query identifies a set of versions of the object data to be searched. A search of the set of versions can be performed according to the query, and results of the search can be returned.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is schematic diagram of an object instance versioning system.

FIG. 3 is a flowchart of an object instance versioning technique.

FIG. 4 is a flowchart of another object instance versioning technique.

### DETAILED DESCRIPTION

Embodiments described herein are directed to techniques and tools for object instance versioning. Such improvements may result from the use of various techniques and tools separately or in combination.

Such techniques and tools may include storing versions of object instances in an object persistence store. The versions may be provided to client applications, which can request that versions of object instances be stored, and can request that current and/or historical versions of the object instances be returned from the store.

The store can maintain versioning information for the object instances. This can include object data versioning information, which can be separate from object method versioning information. Thus, client applications may change object methods (e.g., by adding or changing object class definitions) and/or object data, and the store can still make historical versions of the object instances available. The object persistence store can perform the version change at runtime, storing different object instance versions to the persistence store. The object persistence store can provide a history of an object instance, which can list historical versions of the object instance. The store can also return the current object instance version and/or one or more historical object instance versions, as requested by a client.

Accordingly, the tools and techniques described herein may allow, among other things, storing of different object instance versions in a distributed data store, retrieval of prior versions of an object instance, retrieval of a version history of an object instance, searching of object instances based on specified historical and/or current versions of the object data, and/or versioning of object instance data separate from versioning of object instance methods.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. For example, the various procedures described herein may be implemented with hardware or software, or a combination of both. Moreover, for the sake of simplicity, flowcharts may not show the various ways in which particular techniques can be used in conjunction with other techniques.

### I. Exemplary Computing Environment

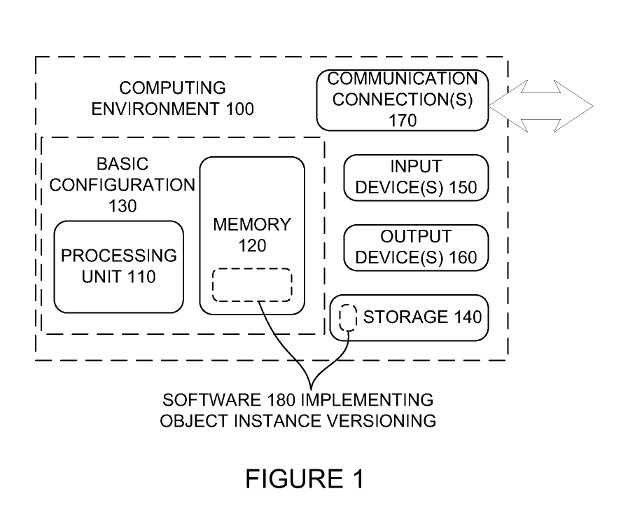

FIG. 1 illustrates a generalized example of a suitable computing environment (100) in which one or more of the described embodiments may be implemented. For example, one or more such computing environments can be used as a data store or client environment. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing object instance versioning.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include non-transitory computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any available media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Object Instance Versioning System

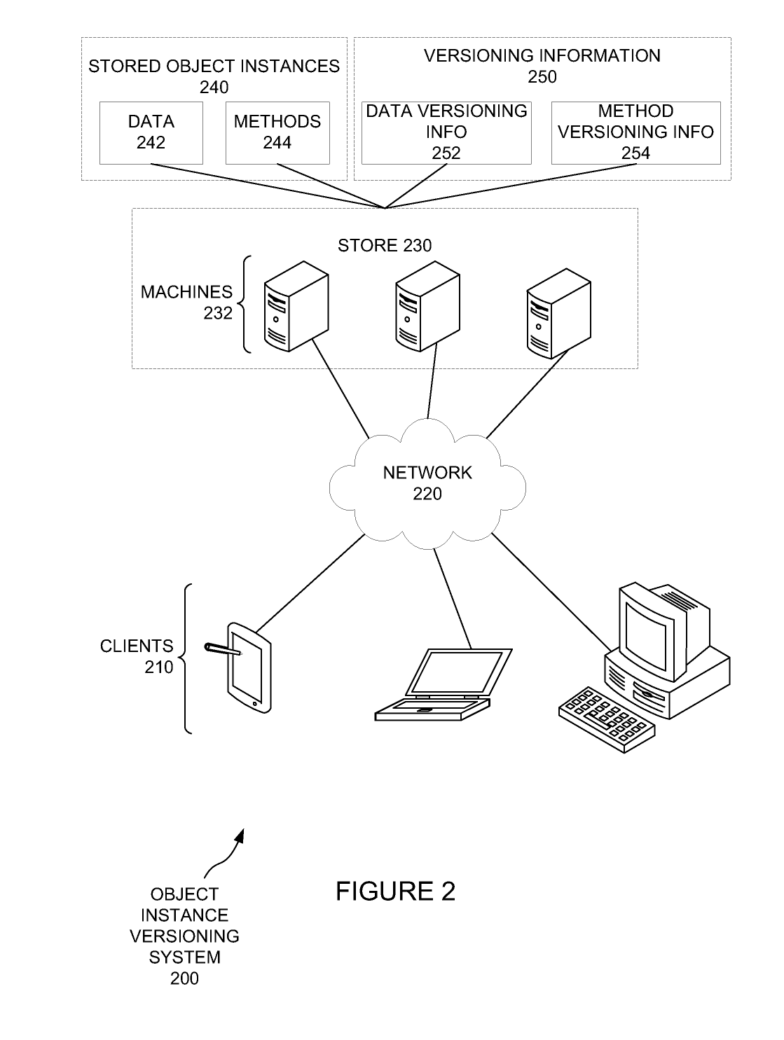

FIG. 2 is a block diagram of an object instance versioning system (200) in conjunction with which one or more of the described embodiments may be implemented. The versioning system (200) can include a set of clients (210), which can be hosted on client machines. The clients (210) can be connected to a network (220), such as a global computer network (e.g., the Internet), an extranet, and/or some other network. Messages such as requests and responses can be sent over the network (220) in any of various ways, such as by using standard messaging techniques (e.g., using TCP/IP, HTTP, etc.). Additionally, the versioning system (200) can include an object persistence store (230), which can be a distributed object persistence store hosted on multiple machines (232). The store (230) can store object instances (240), such as in one or more databases (e.g., Microsoft® SQL Server®databases). For each object instance (240), the store (230) can store a single version of object data (242) and an object method (244) (e.g., an object class to which the object instance belongs). Additionally, the store (230) may store multiple versions of object data (242) and/or multiple versions of an object method (244) for each object instance (240).

The store (230) can also store versioning information (250) to track the multiple object versions. For example, the versioning information (250) may be in the form of a version table that lists versions of the data (242) and methods (244) corresponding to each version of the data (242). However, the versioning information (250) can take various different forms, such as a single table for all versioned object instances in the store (230), a different table for each object instance, or some other type of data structure. The versioning information (250) can include data versioning information (252) to track different versions of the data (242), as well as method versioning information (254) to track different versions of the methods (244) and to correlate versions of the data (242) with corresponding versions of the method (244) used by version of the data (242).

For example, in a situation where the Microsoft®.NET framework is available and the objects stored in the store (230) are .NET objects, the methods (244) can be object classes, and the method versioning information (254) can indicate a version for the object class. Each versioned object class can have a name that includes include the full namespace and version identifier for the class, which can both be part of the method versioning information for the class. For example, the namespace may be “Microsoft.Partner.Customer” and the version identifier for the class may be “Version=2.0.0.0.” This strong name and version identifier can be used to identify the versioned object class. The object persistence store (230) can have a metadata schema to store this information. Each time a new version of an object class is detected, the new schema can be adjusted for each object instance in the class before writing the object instance to the store (230). Accordingly, the object persistence store (230) can record that a different class version is being used, and the object persistence store (230) can store the class definition and the method versioning information (254) (e.g., the version number).

Additionally, if versioning is enabled (versioning may be off by default) and the store (230) receives a request from a client (210) to store an updated object instance, the store (230) can store the new version of the object data (242) without deleting the existing data. Moreover, the store (230) can store data versioning information (252) (e.g., a version number for the data (242) stored in a versioning table) for the new version, and the store (230) can also store method versioning information (254) for the new version (e.g., the object class version number for the method used for the object data (242)). The object persistence store (230) can use the versioning information (250) to retrieve the proper object instance, including matching object data (242) to the proper corresponding object method (244).

The object persistence store (230) can be configured to store object instances (240) with or without object instance version history. If the object instance history or versioning is enabled, the clients (210) can request historic versions by providing an object data version number to the store (230). A current version can be requested by requesting a stored object instance (240) without providing a version number (the default version can be the current version), or by requesting a stored object instance and providing the version number for the object data (242).

The store (230) can be distributed and the object instances (240) can be identified by providing the store (230) with an identifier that need not be tied to a particular physical location or machine. For example, a client (210) may provide a uniform resource identifier or uniform resource locator for the object when requesting the object.

The following is pseudo code for versioning an object class, “Microsoft.Partner.Customer”, which can include a class definition, which forms the method for object instances in the class:

// original object class
class Microsoft.Partner.Customer;1
{

FirstName string,
LastName string

}
//1. add data field: add one string type property name: HomeAddress
// version 2 of object class
class Microsoft.Partner.Customer;2
{

FirstName string,
LastName string,
HomeAddress string

}
//2. change property to complex object: add new address object class and
//change the HomeAddress property to address object.
class Microsoft.Partner.Address;1
{

addressLine1 string,

addressLine2 string,
city string,
state string,
zipCode int

}
// version 3 of object class
class Microsoft.Partner.Customer;3
{

FirstName string,
LastName string,
HomeAddress address,

}

With versioning enabled, the store (230) can save version 1, version 2, and version 3 of the object class. Accordingly, the proper historical object class version can be used along with historical object instance data version, when historic object versions are requested (such as by requesting a particular object data instance). For example, if a version of an object instance in the class was saved while object class version 1 was the active version, the store (230) could populate class version 1 with data from that object instance version.

Following is pseudo code for versioning the object data for an object instance “/Microsoft/Customers/Fred” that is a member of the class, “Microsoft.Partner.Customer”, discussed above:

//Different versions of object instances can be retrieved. The default is
// the current version.

Microsoft.Partner.Customer;3 Fred

// write two versions of Fred instances to object persistence store
ObjectPersistenceService.Write( “/Microsoft/Customers/Fred”, Fred) // v1
ObjectPersistenceService.Write( “/Microsoft/Customers/Fred”, Fred) // v2
// read old version
ObjectPersistenceService.Read(“/Microsoft/Customers/Fred”, “v1”)
// read current version - by default the newest version is set to current
version
ObjectPersistenceService.Read(“/Microsoft/Customers/Fred”)

In this pseudo code, two versions of the object instance “Fred” are written to the store (230), the first version is retrieved, and then the second version is retrieved. In both versions of “Fred”, version 3 of the “Microsoft.Partner.Customer” class were used, so that class version (the method for the object instance Fred) would be populated with data from the appropriate version of the object instance “Fred”.

Storing different versions of object instance data and of methods can be done by storing the entire set of data or method for each version, or by using some other technique. For example, multiple versions may be stored by storing only data that has been changed from a previous version.

Accordingly, the described versioning system (200) includes a distributed object persistence store (230) that can be configured to store multiple versions of object data (242) for object instances (240) in response to receiving requests to store the object instances (240). The store (230) can also be configured so that, upon receiving a request to retrieve an object instance (240), the store (230) can identify a version of the object data (242) responsive to the request and return the identified version. Additionally, the client(s) (210)

can be configured to request storage of object instances (240) in the distributed object persistence store (230) and to request retrieval of the object instances (240) from the distributed object persistence store (230).

Moreover, the store (230) can be configured to return a current version of an object instance (240) in response to a request to retrieve an object instance (240), if the request to retrieve the object instance (240) does not specify an object instance version. Also, the store (230) can be configured to return a specified historical object instance version (i.e., a version of an object instance (240) prior to a current version) in response to a request to retrieve an object instance (240), if the request does specify the historical object instance version.

The store (230) can also be configured to search historical and current versions of data (242) for each of one or more object instances (240) in response to a query received from one of the clients (210). For example, a client (210) could send the store (230) a query to request a search for all employees who currently reside in Seattle, requesting a search of the current version of a “City” property of employee object instances. Alternatively, a query could request a search for employees who reside in or have previously resided in Seattle, requesting a search of current and historical versions of the “City” property of employee object instances. More complex searches could also be performed. For example, a client (210) could send a query to request a search for all employees that have changed residence cities. In response to this query request, a comparison could be made between versions of each client object to determine whether the residence city has changed. Of course, these are merely examples, and many other types of searches could be performed on the current and/or historical versions of object instance data. The searches themselves could be performed using existing types of searching techniques, such as by using an existing database search engine to perform a search over a SQL database (such as a Microsoft® SQL Server® database) in the store (230), where the object instances (240) are stored.

As has been discussed above, the store (230) can be configured to maintain versioning information (250) as a data structure that tracks data versions of object instances stored in the persistence store (230). For example, the data structure may be in the form of a versioning table. Such a versioning table may additionally include the method versioning information (254).

Versioning may be turned off by default, so that the persistence store (230) is configured to maintain multiple versions of object data as described herein only if the store (230) receives a request to maintain multiple versions of object data.

### III. Object Instance Versioning Techniques

Several object instance versioning techniques will now be discussed. Each of these techniques can be performed in a computing environment. For example, each technique may be performed in a computer system that includes at least one processor and a memory including instructions stored thereon that when executed by the at least one processor cause the at least one processor to perform the technique (a memory stores instructions (e.g., object code), and when the processor(s) execute(s) those instructions, the processor(s) perform(s) the technique). Similarly, one or more computer-readable storage media may have computer-executable instructions embodied thereon that, when executed by at least one processor, cause the at least one processor to perform the technique.

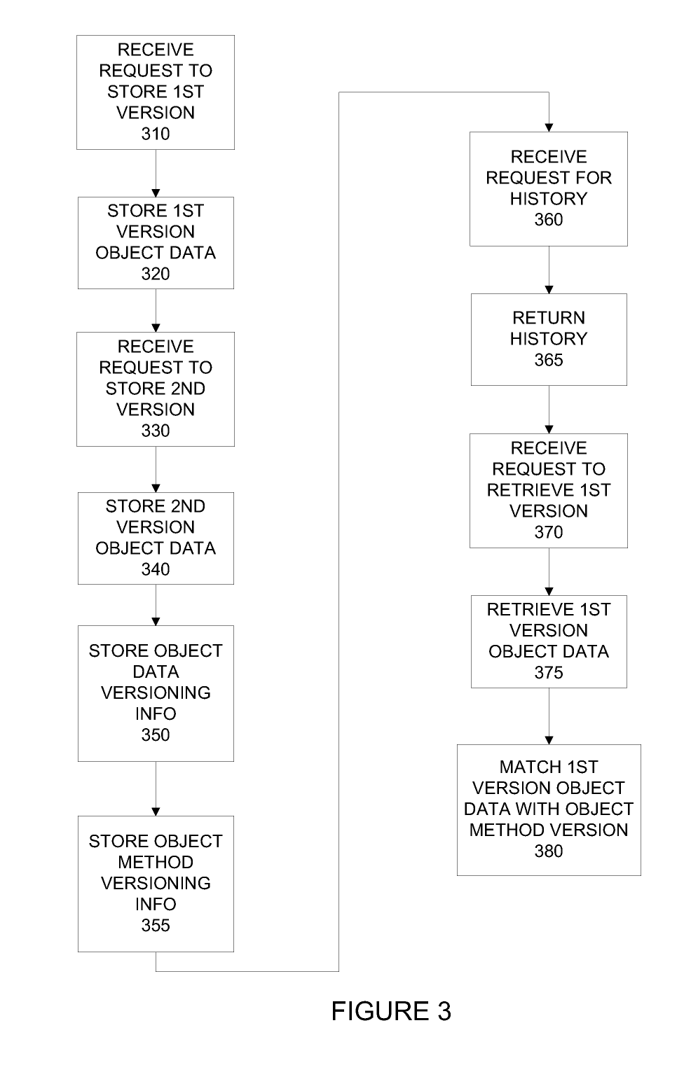

Referring to FIG. 3, an object instance versioning technique will be discussed. In the technique, a request to store a first version of an object instance in an object persistence store can be received (310). In response to that request, a first version of object data for an object instance in the object persistence store can be stored (320). After the first version of the object data is stored (320), a request to store a second version of the object instance in the object persistence store can be received (330). In response to that request to store the second version of the object instance, the second version of the object data can be stored (340) in the store without deleting the first version of the object data. This could include storing the entire second version of the object data, or just storing some portion of the second version of the object data, such as only storing data in the second version that was different from the data in the first version. Additionally, the first and/or second versions could be stored in the store by having them both be stored internally in the same store. Alternatively, the versions can be considered to be stored in the store if one or both of the versions are stored at an external location, with location information (e.g., a pointer) being stored in the store.

The technique of FIG. 3 can also include storing (350) object data versioning information. That versioning information can identify the first version of the object data and the second version of the object data separately from method versioning information for the object instance. The technique may also include storing (355) method versioning information for the object instance separately from the object data versioning information. A request for a history of the object instance can be received (360), and in response, a history of the object instance (which can be a list of data versions of the object instance) can be returned (365). The listed data versions of the object instance can include the first and second versions, and may also include other versions.

One or more of the versions listed in the history can be requested, such as by user input selecting one of the versions from a displayed history list. In response, the requested version(s) can be retrieved from the store. For example, after the second version of the object data is stored (340), the technique can include receiving (370) a request to retrieve the first version of the object instance. This may be done after the history is returned (365) (e.g., by processing user input selecting an entry in the history), or it may be done without the history having been requested or returned. In response to the request to retrieve the first version, the first version of the object data can be retrieved (375) from the store.

The method versioning information can include a first set of method versioning information for an object method version corresponding to the first version of object data for the object instance, and a second set of method versioning information for an object method version corresponding to the second version of the object data for the object instance. The method versioning information could be any of various different types of information, such as the method itself, or some information to identify and/or locate a stored method.

In response to the request to retrieve the first version of the object instance, the technique may also include using the first set of method versioning information to match (380) the first version of the object data with the object method version corresponding to the first version of the object data.

The first and second sets of method versioning information can each include an indication of a version of a class to which at least one version of the object instance belongs. The object method version corresponding to the first version of the object data can be different from the object method version corresponding to the second version of the object data, or it may be the same. The object instance can be an instance of a business object. As used herein, a business object is an object that represents one or more business items, such as an invoice, purchase order, customer, employee, conference room, etc.

The object persistence store can be configured to store multiple versions of any of multiple object types within a software framework. For example, the store may be configured to store any object within a software framework, such as the Microsoft®.NET software framework. Also, the object persistence store can be a distributed object persistence store, and the request to retrieve the first version of the object instance can indicate the object instance without specifying a physical location (physical machine, etc.) where the object instance is stored.

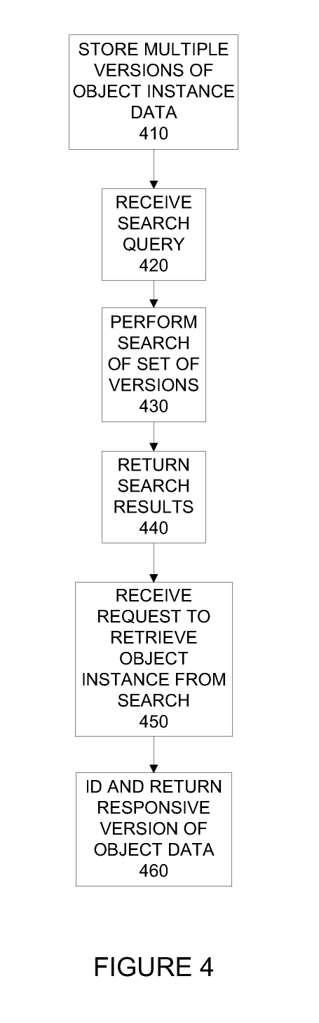

Referring now to FIG. 4, another object instance versioning technique will be discussed. The technique can include storing (410) multiple versions of object data for one or more object instances in an object persistence store in response to receiving requests to store the object instances. The object persistence store can be a distributed object persistence store. The technique can also include receiving (420) a query requesting a search of the object data, the query identifying a set of versions of the object data to be searched. For example, the query may identify all historical versions, or all versions (current and historical) of the object data. A search of the set of versions can be performed (430), and the results can be returned (440). The technique can also include, upon receiving (450) a request to retrieve an object instance identified in the search results, identifying and returning (460) a version of the object data responsive to the request.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A computer-implemented method, comprising:
receiving a request to store a first version of an object instance in an object persistence store;
in response to the request to store the first version of the object instance, storing a first version of object data for an object instance in the object persistence store;
after the first version of the object data is stored, receiving a request to store a second version of the object instance in the object persistence store;
in response to the request to store the second version of the object instance, storing the second version of the object data in the store without deleting the first version of the object data;
storing object data versioning information that identifies the first version of the object data and the second version of the object data separately from method versioning information for the object instance;
after the second version of the object data is stored, receiving a request to retrieve the first version of the object instance; and
in response to the request to retrieve the first version of the object instance, retrieving the first version of the object data from the store.

2. The method of claim 1, further comprising:
receiving a request for a history of the object instance; and
in response to the request for the history, returning a list of data versions of the object instance, the listed data versions of the object instance including the first version and the second version.

3. The method of claim 1, further comprising storing method versioning information for the object instance separately from the object data versioning information.

4. The method of claim 3, wherein the method versioning information comprises a first set of method versioning information for an object method version corresponding to the first version of object data for the object instance, and a second set of method versioning information for an object method version corresponding to the second version of the object data for the object instance.

5. The method of claim 4, further comprising, in response to the request to retrieve the first version of the object instance, using the first set of method versioning information to match the first version of the object data with the object method version corresponding to the first version of the object data.

6. The method of claim 4, wherein the first and second sets of method versioning information each comprise an indication of a version of a class to which at least one version of the object instance belongs.

7. The method of claim 4, wherein the object method version corresponding to the first version of the object data is different from the object method version corresponding to the second version of the object data.

8. The method of claim 1, wherein the object instance is an instance of a business object.

9. The method of claim 1, wherein the object persistence store is configured to store multiple versions of any of multiple object types within a software framework.

10. The method of claim 1, wherein the object persistence store is a distributed object persistence store, and wherein the request to retrieve the first version of the object instance indicates the object instance without specifying a physical location where the object instance is stored.

11. The method of claim 10, wherein:
the method further comprises:
storing a first set of versioning information for an object method version corresponding to the first version of object data for the object instance;
storing a second set of versioning information for an object method version corresponding to the second version of the object data for the object instance; and
in response to the request to retrieve the first version of the object instance, using the first set of versioning information to match the first version of the object data with the object method version corresponding to the first version of the object data;
the first and second sets of versioning information each comprise an indication of a version of a class to which at least one version of the object instance belongs;
the object persistence store is configured to store multiple versions of any of multiple object types within a software framework, without classes for the object types including code that enables versioning; and
the object persistence store is a distributed object persistence store, and wherein the request to retrieve the first version of the object instance indicates the object instance without specifying a physical location where the object instance is stored.

12. A computer system comprising:
a distributed object persistence store configured to store multiple versions of object data for object instances in response to receiving requests to store the object instances, and upon receiving a request to retrieve an object instance, to identify a version of the object data responsive to the request and to return the identified version; and
a set of one or more clients configured to request storage of object instances in the distributed object persistence store and to request retrieval of the object instances from the distributed object persistence store.

13. The computer system of claim 12, wherein the store is configured to return a current object instance version in response to a request to retrieve an object instance, if the request to retrieve the object instance does not specify an object instance version.

14. The computer system of claim 12, wherein the store is configured to return a specified historical object instance version in response to a request to retrieve an object instance, if the request specifies the historical object instance version.

15. The computer system of claim 12, wherein the store is configured to search multiple versions of data for one or more object instances in response to a query sent from one of the clients.

16. The computer system of claim 12, wherein the store is configured to maintain a data structure that tracks data versions of object instances stored in the data store.

17. The computer system of claim 16, wherein the data store is configured to maintain multiple versions of object data only if the store receives a request to maintain multiple versions of object data.

18. One or more computer-readable storage media having computer-executable instructions embodied thereon that, when executed by at least one processor, cause the at least one processor to perform acts comprising:
storing multiple versions of object data for one or more object instances in an object persistence store in response to receiving requests to store the one or more object instances;
receiving a query requesting a search of the object data, the query identifying a set of versions of the object data to be searched;
performing a search of the set of versions according to the query; and
returning results of the search.

19. The one or more computer-readable storage media of claim 18, wherein the acts further comprise, upon receiving a request to retrieve an object instance identified in the results of the search, identifying a version of the object data responsive to the request and returning the identified version.

20. The one or more computer-readable storage media of claim 18, wherein the object persistence store is a distributed store.
